(19) United States
(12) Patent Application Publication
(10) Pub. No.: US 2012/0048147 A1
(43) Pub. Date: Mar. 1, 2012

(54) Low Shrinkage Binder System

(76) Inventors: Uwe Gehrig, St. Georgen (DE); Florian Ellenrieder, Augsburg (DE)

(21) Appl. No.: 13/265,255

(22) PCT Filed: Mar. 30, 2010
(86) PCT No.: PCT/EP2010/054158

§ 371 Date: Oct. 26, 2011

(30) Foreign Application Priority Data
Apr. 22, 2009 (EP) 09158500.0

(51) Int. Cl. C04B 16/00; C04B 14/04; C04B 14/10; C04B 14/00

(52) U.S. Cl. 106/661; 106/483; 106/405; 106/491; 106/487; 106/471; 106/489

(57) ABSTRACT

The invention relates to mixtures containing alkali-activatable aluminosilicate binders, characterized in that the mixture contains vegetable oils and/or fats, and furthermore to the use of the vegetable fats and/or oils for reducing shrinkage and for imparting water repellency in alkali-activatable aluminosilicate binders. The invention also relates to grouts, levelling compounds or coatings in which the mixtures according to the invention are present.

The present invention relates to mixtures containing alkali-activatable aluminosilicate binders, preferably solid binder mixtures, particularly preferably building material mixtures which contain vegetable oils and/or fats for reducing shrinkage. The invention furthermore relates to the use of vegetable oils and/or fats as shrinkage reducers in alkali-activatable aluminosilicate binders. The invention also relates to grouts, levelling compounds or coatings which contain the mixtures according to the invention.

Alkali-activatable aluminosilicate binders are inorganic binder systems which are based on reactive water-insoluble oxides based on, inter alia, silica in combination with alumina. They harden in an aqueous alkaline medium. Such binder systems are also generally known by the term geopolymers. Geopolymers are described, for example, in the documents EP 0 026 687, EP 0 153 097 B1 and WO 82/00816.

For example, ground granulated blast furnace slag, metakaolin, clinker, flyash, activated clay or a mixture thereof can be used as the reactive oxide mixture. The alkaline medium for activating the binder usually consists of aqueous solutions of alkali metal carbonates, sulphates or fluorides and in particular alkali metal hydroxide and/or soluble waterglass. The hardened binders have high mechanical and chemical stability. In comparison with cement, they may be more economical and more stable and may have more advantageous CO₂ emission balance.

EP 1 236 702 A1 describes, for example, a waterglass-containing building material mixture for the production of mortars resistant to chemicals and based on a latently hydraulic binder, waterglass and metal salt as a control agent. Granulated blast furnace slag can also be used as the latently hydraulic constituent. Alkali metal salts are mentioned and are used as the metal salt.

The literature reference Alkali-Activated Cements and Concretes, Caijun Shi, Pavel V. Krivenko, Della Roy, (2006), 30-63 and 277-297, gives a review of substances suitable as alkali-activatable aluminosilicate binders.

Alkali-activatable aluminosilicate binders have the advantage that many products otherwise occurring as waste in energy or steel production (binders such as ground granulated blast furnace slag, flyash, clinker etc.) can be put to expedient use. They are therefore distinguished by an advantageous energy balance (CO₂ emission balance).

Owing to the relatively low proportion of phases in the binder which are typically involved in the hydraulic setting reaction of cements, such as, for example, calcium silica hydrate (CSH), calcium aluminate hydrate (CAH) and calcium aluminate silicate hydrate (CASH), very good resistance to attack by acids can be achieved with these binders (Alkali-Activated Cements and Concretes, Caijun Shi, Pavel V. Krivenko, Della Roy, (2006), 185-191, in particular Section 9.4 Acid attack).

A major disadvantage of the known building material mixtures based on alkali-activatable aluminosilicate binders is, however, the so-called shrinkage. In the alkali-activated curing process, volume contraction of the curing binder occurs in an undesired manner due to the resulting condensation. This effect is substantially more pronounced in comparison with the shrinkage of cementitious binders in which a hydration reaction and not a condensation reaction takes place. Average values of the shrinkage after 28 days under standard conditions according to DIN 12808-4 are, for example, in the range up to 10 mm/m in the case of aluminosilicate binders at relative humidities up to 50%, in comparison with 0 to 2 mm/m in the case of cement.

As in the case of cementitious binder systems, the shrinkage leads to a substantially poorer quality of the hardened building materials also in the case of the alkali-activatable aluminosilicate binders. In particular, cracks on the surface of the building material may occur. Another disadvantage is that, apart from an unattractive aesthetic impression, the stability to environmental influences is also reduced (Alkali-Activated Cements and Concretes, Caijun Shi, Pavel V. Krivenko, Della Roy, (2006), 176-199, in particular Chapter 7, Durability of alkali-activated cements and concretes). In particular, the resistance to the penetration of water, salts (in particular chlorides but also sulphates) and chemicals, in particular acids, deteriorates. The resistance to freezing and thawing is also reduced. The lifetime of the building materials is accordingly shortened. The fact that, as a result of penetration of water, salts, chemicals (acids), the corrosion of the generally present structural steel is very greatly promoted is to be regarded as particularly problematic.

The problem of shrinkage both in the case of cementitious systems and in the case of alkali-activatable aluminosilicate binders is known in the prior art. The literature is concerned with reducing the shrinkage of cementitious systems; particularly frequently, alcohols (e.g. low molecular weight polymers of ethylene oxide and propylene oxide and glycols) are used, as described, for example, in the documents EP-A-1 914211 and U.S. Pat. No. 5,603,760.

The shrinkage behaviour and influences which increase or reduce the shrinkage of systems not based on cement are described in Alkali-Activated Cements and Concretes, Caijun Shi, Pavel V. Krivenko, Della Roy, (2006), 131-134 and 165-169. Usually, an attempt is made to minimize the shrinkage by a suitable choice and combination of the base raw materials, i.e. the aluminosilicate binder (for example flyash, clinker, metakaolin), to a level tolerable according to the application, the activator generally also making a major contribution to the shrinkage behaviour. For example, with the use of waterglass as an activator, very pronounced autogenous shrinkage (chemical shrinkage) occurs, which can be substantially reduced, for example, by substitution of the waterglass by sodium hydroxide solution (Alkali-Activated Cements and Concretes, Caijun Shi, Pavel V. Krivenko, Della Roy, (2006), 165-167, in particular Section 6.8.2 Effect of activator). Owing to the circumstances described above, the person skilled in the art is limited in the choice of the binders and the combinations thereof by the shrinkage factor. Binders and activator compositions which would actually have good final properties, such as, for example, good compressive strength, scratch resistance and/or resistance to freezing and thawing, can be used in practice only with difficulty, if at all, owing to the excessive shrinkage in the case of some materials. It should also be borne in mind that, as a result of the optimization of the binders and activators with regard to the shrinkage, the other end product properties are also changed. In order to obtain the desired product properties (little shrinkage and abovementioned end product properties), it is therefore necessary to optimize a complex system of parameters dependent on one another.

In addition to the autogenous shrinkage, there is the so-called drying shrinkage (Alkali-Activated Cements and Concretes, Caijun Shi, Pavel V. Krivenko, Della Roy, (2006), 133-134, in particular Section 5.5.2 Drying shrinkage). This can be influenced by changing the ambient conditions (curing conditions, such as, in particular, temperature and atmospheric humidity). Thus, this shrinkage component is vanishingly small at 100% atmospheric humidity and very large at very low atmospheric humidities. In order to ensure a very high and constant product quality, in particular the shrinkage should depend as little as possible on the curing conditions. In practice, strict compliance with the ideal curing conditions would not be possible in most cases and this would in the end lead to large quality variations. It is for this reason that an effective method for shrinkage reduction as far as possible substantially independent of constraints such as temperature and atmospheric humidity should lead to good success in reducing shrinkage.

In Effect of shrinkage-reducing admixtures on the properties of alkali-activated slag mortars and pastes, Palacios, M. Puertas, F., Cement and Concrete Research (2007), 37(5), 691-702, the effect of shrinkage reducers based on polypropylene glycol in alkali-activatable binder systems is investigated. As in the area of cementitious binder systems, the investigations with regard to alkali-activatable aluminosilicate binders in the literature concentrate on generally low molecular weight shrinkage reducers (generally alcohols) which are know from the cement sector and are capable of reducing the surface tension of the mixing water.

The use of oils and fats in alkali-activatable aluminosilicate binders and in particular as shrinkage-reducing agents is not known.

It was an object of the present invention to provide building material mixtures which substantially avoid the abovementioned disadvantages of the prior art and in particular minimize the shrinkage. This is to be permitted in combination with a good price/performance ratio, good environmental compatibility (waste balance and CO₂ emission balance) and good stability to environmental influences, in particular good acid stability of the building material mixtures. Moreover, the effectiveness with regard to shrinkage reduction is to be improved, i.e. as far as possible greater shrinkage reduction than that known in the prior art is to be achieved.

This object could be achieved by the mixtures according to the invention which contain alkali-activatable aluminosilicate binders, preferably solid binders, particularly preferably latently hydraulic binders (such as ground granulated blast furnace slag) and/or pozzolanas (for example natural pozzolanas obtained from ashes and rocks of volcanic origin and/or synthetic pozzolanas, such as flyashes, silica dust (microsilica), calcined ground clay and/or oil shale ash), particularly preferably ground granulated blast furnace slag, flyash, microsilica, clinker, activated clay and/or metakaolin mixtures and vegetable oils and/or fats, preferably oils, particularly preferably vegetable oils.

This object is likewise achieved by the use of mixtures according to the invention for reducing shrinkage and/or imparting water repellency in alkali-activatable aluminosilicate binders. Imparting water-repellency to building materials enables in particular the penetration of water to be reduced by the water-repellent effect and hence further improvement in the stability to environmental influences to be achieved. The object is advantageously also achieved in grouts, levelling compounds or coatings which contain the mixtures according to the invention.

The mixtures according to the invention, also referred to below as building material mixture, have the advantage that low-shrinkage and high-quality mortars and concretes, in particular grouts, levelling compounds and coatings for the building industry, can be economically realized with them. Surprisingly, it was found that oils and/or fats have shrinkage-reducing properties.

For example, ground granulated blast furnace slag, kaolin, metakaolin, clinker, flyash, microsilica, activated clay, silicon oxides, trass, pozzolana, kieselguhr, diatomaceous earth, gaize, aluminium oxides and/or mixed aluminium/silicon oxides can be used as binders in the mixtures according to the invention. These substances are also known by the general terms latent hydraulic binders and pozzolanas. One or more of said binders can be used. Ground granulated blast furnace slag is most preferred.

Usually, the composition of mineral binders is stated as the respective oxide. However, this does not mean that the respective elements also are or must be present in the form of the oxides. The statement as oxide is only a standardized form of representation of the analytical results, as is usual in this technical area. The oxide composition of the preferably pulverulent, alkali-activatable binders and binder mixtures varies in relatively wide ranges according to the type of binder. In a list which is not definitive, SiO₂ (preferably in an amount of 20 to 95% by weight, particularly preferably 30 to 75% by weight), Al₂O₃ (preferably 2-70% by weight, particularly preferably 5 to 50% by weight), CaO (preferably 0-60% by weight, particularly preferably 0 to 45% by weight, especially preferably 2 to 35% by weight) and M₂O (M=alkali metal, 0 to 40% by weight, particularly preferably 0.5 to 30% by weight) may be mentioned as the most important oxides.

In contrast to cements, aluminosilicate binders have for the most part amorphous and low-calcium phases. Owing to the high crystalline fraction of calcium silicate, calcium aluminate and calcium silicate aluminates, the cementitious clinker phases become hydrated on addition of water to give calcium silicate hydrates, calcium aluminate hydrates and calcium silicate aluminate hydrates. However, these are only moderately stable to acids. Owing to the high amorphous fraction or owing to the relatively low content of calcium in alkali-activatable aluminosilicate binders (Portland cement: generally greater than 50% by weight of CaO), phases which differ substantially from the cementitious phases accordingly form. Consequently, the content of Ca (usually stated as CaO) in the aluminosilicate binder should be in the quantity range stated in the preceding section, in order to ensure good acid resistance.

Oils and/or fats are used as shrinkage reducers. These hydrophobic natural products are environmentally compatible, biodegradable and easily available at a favourable price. For example, vegetable oils, preferably selected from the group consisting of sunflower oil, soya oil, safflower oil, olive oil, rapeseed oil, palm oil, peanut oil, colza oil, cottonseed oil and/or linseed oil, can be used. Sunflower oil is particularly preferred. Particularly preferred are vegetable oils which are liquid at temperatures greater than 0° C., in order to also ensure sufficient efficiency at low temperatures. Oils, in particular vegetable oils, are preferred to fats, which are generally of animal origin (for example beef tallow).

The vegetable oils and/or fats are preferably present in an amount of 0.01 to 15% by weight, preferably 0.02 to 10% by weight and particularly preferably 0.05 to 8% by weight in the mixtures.

In a particularly preferred embodiment of the invention, the mixture contains, as binders, ground granulated blast furnace slag, flyashes and/or microsilica. The better acid resistance of the binder (mixtures), owing in particular to their preferably high proportion of aluminate and silicate, is advantageous here. Said binders are amorphous to a high degree and have relatively large and reactive surface areas. Consequently, the setting behaviour is accelerated. The proportion of aluminate (as Al₂O₃) and silicate (as SiO₂) should in total preferably account for more than 50% by weight, particularly preferably more than 60% by weight, based on the total mass of the binder (mixture). Ground granulated blast furnace slag as a particularly preferred alkali-activatable aluminosilicate binder can preferably be used in an amount between 5 and 90% by weight, particularly preferably between 5 and 70% by weight, based in each case on the total weight of the mixture. The ground granulated blast furnace slag, preferably in the abovementioned amount, can be used alone or preferably together with pozzolanas, particularly preferably with microsilica and/or flyash.

In a further preferred embodiment, metakaolin is present as the binder. The metakaolin can preferably be present in a proportion by weight of 1 to 60% by weight, particularly preferably 5 to 60% by weight, based in each case on the total weight of the mixture. Metakaolin can be used as a binder alone or in combination with one or more alkali-activatable aluminosilicate binders, preferably selected from the group consisting of ground granulated blast furnace slag, flyashes and/or microsilica. Metakaolin is thermally treated kaolin and, owing to its large amorphous fractions, is particularly reactive. It also sets rapidly, in particular with a high degree of grinding.

In a further preferred embodiment of the invention, the binders used are characterized in that they have a specific surface area (Blaine value) greater than 2000 cm²/g, particularly preferably from 4 000 to 4500 cm²/g. A high Blaine value will in general lead to high strengths and high setting reactivity.

In a preferred embodiment of the invention, the mixture contains vegetable oils.

Also particularly advantageous are embodiments of the invention in which cement is present in the mixtures, preferably in an amount of 0 to 50% by weight, preferably 0 to 25% by weight, particularly preferably 0 to 15% by weight and most preferably 0 to 10% by weight. High-alumina cement having a relatively high proportion of alumina is preferred to Portland cement (OPC).

The alkaline cement acts as an activator on mixing with water so that setting or hardening occurs. In a particularly advantageous manner, it is possible to provide a 1-component system (1C system=mixture of binder and an activator, such as, for example, cement) which can be activated only by addition of water for setting and hardening. The presence of cement is also advantageous if, in addition to the stability to acids, stability to alkalis is also to be improved. The calcium silicate hydrate (CSH) and calcium silicate aluminate (CSA) phases in the cement have in fact the property of being relatively stable to alkalis. By a suitable choice of the binders, it is therefore possible to control the properties of the hardened building materials.

Mixtures according to the invention which contain no cement are preferred. In particular, these are suitable for the preparation of particularly acid-resistant building material mixtures.

In a preferred embodiment of the invention, an activator is present and said activator is particularly preferably pulverulent.

The activator may also be used in the form of a solution. In this case, the activator solution is usually mixed with an alkali-activatable binder or a binder mixture, whereupon curing occurs.

Preferably, the mixtures contain, as activator, at least one alkali-metal compound, e.g. alkali metal silicates, alkali metal sulphates, carbonates of alkali metals or alkaline earth metals, such as, for example, magnesium carbonate, calcium carbonate, potassium carbonate, sodium carbonate, lithium carbonate, cement, alkali metal salts or organic and inorganic acids; sodium hydroxide, potassium hydroxide and lithium hydroxide and/or calcium hydroxide or magnesium hydroxide are particularly preferred.

In principle, any compound which is alkaline in aqueous systems can be used.

In a preferred embodiment of the invention, alkali metal and/or alkaline earth metal hydroxides are used as the activator. The alkali metal hydroxides are preferred owing to their high alkalinity.

The use of waterglass is furthermore preferred, preferably liquid waterglass, in particular alkaline potassium or sodium waterglass. This may be Na, K or lithium waterglass, potassium waterglass being particularly preferred. The modulus (molar ratio of SiO₂ to alkali metal oxide) of the waterglass is preferably less than 4, preferably less than 2. In the case of waterglass powder, the modulus is less than 5, preferably between 1 and 4, particularly preferably between 1 and 3.

In a further preferred embodiment, the mixtures contain at least one alkali metal aluminate, carbonate and/or sulphate as activators.

The activator can be used in aqueous solution. The concentration of the activator in the solution may be based on the generally customary practice. The alkaline activation solution preferably comprises sodium, potassium or lithium hydroxide solutions and/or sodium, potassium or lithium silicate solutions having a concentration of 0.1 to 60% by weight of solid, preferably 1 to 55% by weight of solids. The amount used in the binder system is preferably 5 to 80% by weight, particularly preferably 10 to 70% by weight, especially preferably 20 to 60% by weight.

Particularly preferred mixtures are those which contain:

between 5 and 90% by weight,

preferably between 5 and 70% by weight,

particularly preferably between 10 and 60% by weight,

of ground granulated blast furnace slag,

between 0 and 70% by weight,

preferably between 5 and 70% by weight, particularly preferably between 5 and 50% by weight, of microsilica and/or flyashes.

In addition, the mixture may contain between 0.1 and 90% by weight, preferably between 1 and 80% by weight,

particularly preferably between 2 and 70% by weight, of, preferably, aqueous activator solutions or, particularly preferably, pulverulent activators.

The stated weights are based in each case on the total weight of the mixture.

The oils and/or fats according to the invention can preferably be mixed with the alkali-activatable, preferably pulverulent aluminosilicate binders. These are preferably applied as a coating to the binder or binders and/or filler or fillers.

It is also possible additionally to mix preferably pulverulent activator according to one of the preferred embodiments of the invention with the binder or to coat the binder and/or optionally the fillers therewith. This gives a one-component system which can be activated only by addition of water for curing.

Two-component systems (2-C systems) are characterized in that an activator, preferably an aqueous activator solution, is added to the binder. Once again, the generally alkaline activator systems according to the preferred embodiments of the invention are suitable as activator. It is preferably also possible to use the oils and/or fats according to the invention which are suitable as shrinkage reducers in the aqueous activator solution. It is advantageous to produce stable emulsions by addition of suitable surfactants, such as, for example, sodium dodecyl sulphate, in order to prevent phase separation of the oils and/or fats in the aqueous environment.

In a particularly preferred embodiment of the invention, the following components are present in the mixture:

between 0.01 and 15% by weight, preferably 0.02 to 10% by weight and particularly preferably 0.05 to 8% by weight of vegetable oil, preferably selected from the group consisting of sunflower oil, soya oil, olive oil, rapeseed oil, palm oil, peanut oil, colza oil, cottonseed oil and/or linseed oil, particularly preferably sunflower oil, particularly preferably vegetable oils which are liquid at temperatures greater than 0° C., between 1 and 90% by weight of alkali-activatable aluminosilicate binder, preferably 5 to 80% by weight, particularly preferably 10 to 70% by weight, preferably solid binders, particularly preferably latently hydraulic binders (such as ground granulated blast furnace slag), and/or pozzolanas (for example natural pozzolanas obtained from ashes and rocks of volcanic origin and/or synthetic pozzolanas, such as flyashes, silica dust (microsilica), calcined ground clay and/or oil shale ash), particularly preferably ground granulated blast furnace slag, flyash, microsilica, clinker, activated clay and/or metakaolin, and between

0.1 and 90% by weight of activator, preferably 1 to 80% by weight, particularly preferably 2 to 70% by weight. The stated weights are based in each case on the total weight of the mixture.

Optionally, between 0 and 80% by weight, particularly preferably between 30 and 70% by weight, of fillers and optionally between 0 and 15% by weight of additives, preferably additives different from the abovementioned components, may be present in the mixtures.

The stated weights are based in each case on the total weight of the mixture.

The binder system according to the invention is preferably used for the production of mortars and concretes. For the production of such mortars and concretes, the binder system described above is usually mixed with further components, such as fillers, latently hydraulic substances and further additives. The addition of the pulverulent activator is preferably effected before said components are mixed with water, so that a so-called factory dry mortar is produced. Thus, the activation component is present in pulverulent form, preferably as a mixture with the binders and/or sand. Alternatively, an aqueous, preferably alkaline activation solution can be added to the other pulverulent components. In this case, a two-component binder is then referred to.

Generally known gravels, sands and/or flours, for example based on quartz, limestone, barite or clays, are suitable as filler. Light fillers, such as pearlite, kieselguhr (diatomaceous earth), expanded mica (vermiculite) and foamed sand, can be used as the filler. The proportion of the fillers in the mortar or concrete can usually be between 0 and 80% by weight, based on the total weight of the mortar or concrete, depending on the application.

Suitable additives are generally known superplasticizers, antifoams, water retention agents, pigments, fibres, dispersion powders, wetting agents, retardants, accelerators, complexing agents, aqueous dispersions and rheology modifiers.

The invention also relates to the use of vegetable fats and/or oils, preferably selected from the group consisting of sunflower oil, soya oil, olive oil, rapeseed oil, palm oil, peanut oil, colza oil, cottonseed oil and/or linseed oil, particularly preferably sunflower oil, particularly preferably vegetable oils which are liquid at temperatures greater than 0° C., for reducing shrinkage in alkali-activatable aluminosilicate binders, preferably solid binders, particularly preferably latently hydraulic binders (such as ground granulated blast furnace slag) and/or pozzolanas (for example natural pozzolanas obtained from ashes and rocks of volcanic origin and/or synthetic pozzolanas, such as flyashes, silica dust (microsilica), calcined ground clay and/or oil shale ash), particularly preferably ground granulated blast furnace slag, flyash, microsilica, clinker, activated clay and/or metakaolin.

The invention also relates to the use of vegetable fats and/or oils, preferably selected from the group consisting of sunflower oil, soya oil, olive oil, rapeseed oil, palm oil, peanut oil, colza oil, cottonseed oil and/or linseed oil, particularly preferably sunflower oil, particularly preferably vegetable oils which are liquid at temperatures greater than 0° C., for imparting water repellency to alkali-activatable aluminosilicate binders, preferably solid binders, particularly preferably latently hydraulic binders (such as ground granulated blast furnace slag) and/or pozzolanas (for example natural pozzolanas obtained from ashes and rocks of volcanic origin, or synthetic pozzolanas, such as flyashes, silica dust (microsilica), calcined ground clay and/or oil shale ash), particularly preferably ground granulated blast furnace slag, flyash, microsilica, clinker, activated clay and/or metakaolin.

The vegetable oils and/or fats are suitable in each case for use for shrinkage reduction and for imparting water repellency for all aluminosilicate binders described in this invention.

The present invention furthermore relates to grouts, levelling compounds or coatings which contain the mixtures according to the invention.

### EXAMPLES

### Sample Preparation:

The preparation of the mixtures is expediently effected by first premixing all pulverulent constituents according to Table 1. Thus, for example, the binders ground granulated blast furnace slag, microsilica and/or metakaolin are premixed together with the quartz sand filler in the first step.

For the preparation of the mixtures according to the invention (M1a, M2a and M3a), this mixture is sprayed with the respective oil and mixed again in the second step.

The preparation of a homogeneous mixture by addition of the activator with stirring is then effected according to DIN EN 196.

### Production and Storage of the Test Specimens, and Tests:

Test prisms having the dimensions 4×4×16 cm³ are produced from the stirred binders according to DIN EN 196 and are stored according to said standard at a temperature of 23° C. and a relative humidity of 50%. The shrinkage measurement was then effected, also according to the abovementioned standard.

All mixtures mentioned comprise two components, since the activators (potassium waterglass or sodium hydroxide solution) are added separately. The mixtures M1, M2, M3, M4 and M5 are mentioned as comparative systems and, in comparison with M1a, M1b, M1c, M2a, M3a, M4a and M5a, contain no organic additive. M1a is a comparative example comprising a shrinkage reducer not according to the invention.

### Example 1

TABLE 1
Experimental formulations, data in parts by weight

| Raw materials | M1 | M1a | M1b | M1c |
|---|---|---|---|---|
| Ground granulated blast furnace slag | 200 | 200 | 200 | 200 |
| Microsilica | 50 | 50 | 50 | 50 |
| Metakaolin | | | | |
| Quartz sand | 750 | 750 | 750 | 750 |
| Pluriol P600 (from BASF) | | 10 | | |
| Sunflower oil | | | 10 | |
| Safflower oil | | | | 10 |
| Potassium waterglass | 250 | 250 | 250 | 250 |
| (modulus 1, solids content 40%) | | | | |

TABLE 2
Results of the shrinkage measurement

| Age/days | M1 | M1a | M1b | M1c |
|---|---|---|---|---|
| 1 | 0.00 | 0.00 | 0.00 | 0.00 |
| 2 | −1.28 | −1.29 | −0.75 | −0.93 |
| 5 | −2.99 | −2.71 | −1.93 | −2.17 |
| 7 | −3.48 | −3.13 | −2.33 | −2.54 |
| 14 | −4.19 | −3.81 | −2.89 | −3.07 |
| 21 | −4.56 | −4.04 | −3.18 | −3.34 |
| 28 | −4.75 | −4.21 | −3.34 | −3.49 |
| Shrinkage reduction | | 11% | 30% | 27% |
| after 28 d | | | | |

On comparison with the shrinkage values after 28 days, a substantial reduction in shrinkage as a result of addition of sunflower oil (M1b) or safflower oil (M1c) is evident. The reduction in shrinkage is significantly higher in the case of the two vegetable oils in comparison with known polyethylene glycols as shrinkage-reducing additive (M1a).

### Example 2

TABLE 3
Experimental formulations, data in parts by mass

| Raw materials | M2 | M2a | M3 | M3a |
|---|---|---|---|---|
| Ground granulated blast furnace slag | | | | |
| Coal flyash | | | 50 | 50 |
| Metakaolin | 200 | 200 | 130 | 130 |
| Portland cement 52.5R | | | 20 | 20 |
| Quartz sand | 800 | 800 | 800 | 800 |
| Sunflower oil | | 10 | | 10 |
| Potassium waterglass | 350 | 350 | 280 | 280 |
| (modulus 1, solids content 40%) | | | | |

TABLE 4
Results of the shrinkage measurement

| Age/days | M2 | M2a | M3 | M3a |
|---|---|---|---|---|
| 1 | 0.00 | 0.00 | 0.00 | 0.00 |
| 2 | −3.86 | −3.33 | −3.69 | −2.67 |
| 5 | −4.80 | −3.77 | −4.59 | −3.67 |
| 7 | −4.83 | −3.77 | −4.67 | −3.73 |
| 14 | −4.79 | −3.79 | −4.70 | −3.81 |
| 21 | −4.84 | −3.90 | −4.74 | −3.85 |
| 28 | −4.85 | −3.94 | −4.74 | −3.86 |
| Shrinkage reduction | | 19% | | 19% |
| after 28 d | | | | |

Both in the case of metakaolin as the sole binder (M2 and M2a) and in the case of the binder composition comprising coal flyash, metakaolin and Portland cement, a reduction in the shrinkage is evident.

### Example 3

TABLE 5
Experimental formulations, data in parts by mass

| Raw materials | M4 | M4a | M5 | M5a |
|---|---|---|---|---|
| Ground granulated blast furnace slag | 200 | 200 | 150 | 150 |
| Microsilica | 50 | 50 | | |
| Metakaolin | | | 50 | 50 |
| Coal flyash | | | 50 | 50 |
| Quartz sand | 750 | 750 | 750 | 750 |
| Sunflower oil | | 10 | | 10 |
| Potassium waterglass | | | 240 | 240 |
| (modulus 1, solids content 40%) | | | | |
| Sodium hydroxide solution | 180 | 180 | | |
| (10% strength) | | | | |

TABLE 6
Results of the shrinkage measurement

| Age/days | M4 | M4a | M5 | M5a |
|---|---|---|---|---|
| 1 | 0.00 | 0.00 | 0.00 | 0.00 |
| 2 | −0.09 | −0.10 | −3.88 | −2.15 |
| 5 | −0.38 | −0.31 | −5.77 | −3.57 |
| 7 | −0.58 | −.041 | −6.21 | −3.91 |
| 14 | −0.94 | −0.61 | −6.95 | −4.49 |
| 21 | −1.13 | −0.70 | −7.28 | −4.77 |
| 28 | −1.32 | −0.78 | −7.44 | −4.90 |
| Shrinkage reduction | | 41% | | 34% |
| after 28 d | | | | |

The positive influence of the vegetable oils with regard to the shrinkage also occurs in the case of different liquid components (for example sodium hydroxide solution in M4 and M4a). Further binder variations, as in the mixture M5, can also be prepared with reduced shrinkage by the use of vegetable oil.

The experiments show the surprisingly good efficiency of the shrinkage reducers according to the invention over a wide range of different binder compositions and in comparison with the shrinkage reducer Pluriol P600 based on polyethylene glycol.

1. Mixture containing alkali-activatable aluminosilicate binders, wherein the mixture contains vegetable oils and/or fats.

2. Mixture according to claim 1, wherein the mixture contains ground granulated blast furnace slag, flyash and/or microsilica as the binder.

3. Mixture according to claim 1, wherein the mixture contains metakaolin as the binder.

4. Mixture according to claim 1, wherein the binders have a specific surface area (Blaine value) greater than 2000 cm²/g.

5. Mixture according to claim 1, wherein the mixture contains vegetable oils.

6. Mixture according to claim 1, wherein the mixture contains from 0 to 50% by weight of cement.

7. Mixture according to claim 1 wherein the mixture contains no cement.

8. Mixture according to claim 1, wherein the mixture contains activator.

9. Mixture according to claim 8, wherein the mixture contains an alkali metal compound as the activator.

10. Mixture according to claim 8, wherein the mixture contains alkali metal and/or alkaline earth metal hydroxides as the activator.

11. Mixture according to claim 8, wherein the mixture contains alkaline waterglass as the activator.

12. Mixture according to claim 1, wherein the following components are present in the mixture:
between 0.01 and 15% by weight of vegetable oil,
between 1 and 90% by weight of alkali-activatable aluminosilicate binder,
the stated rates in each case being based on the total weight of the mixture.

13. (canceled)

14. (canceled)

15. Grouts, levelling compounds or coatings containing mixtures according to claim 1.

16. A Process comprising premixing alkali-activatable aluminosilicate binder constituents to form a mixture, adding vegetable fat and/or oil to the mixture, and adding thereto an activator.
